(19) United States
(12) Patent Application Publication
(10) Pub. No.: US 2026/0300845 A1
(43) Pub. Date: Oct. 1, 2026

(54) MACHINE LEARNING-BASED METHODS AND SYSTEMS FOR PREDICTING VEHICLE PERFORMANCE

(71) Applicants: Jack SCHNEIDER, Bellevue, WA (US); Ohio State Innovation Foundation, Columbus, OH (US); PACCAR INC, Bellevue, WA (US)

(72) Inventors: Qadeer AHMED, Plain City, OH (US); Manfredi VILLANI, Columbus, OH (US); Sharat SUBRAYA-HEGDE, Columbus, OH (US); Maarten MEIJER, Mount Vernon, WA (US); Jack SCHNEIDER, Mountlake Terrace, WA (US)

(21) Appl. No.: 19/489,130

(22) PCT Filed: Jun. 3, 2024
(86) PCT No.: PCT/US2024/032253

§ 371 Date: Dec. 1, 2025

Related U.S. Application Data
(60) Provisional application No. 63/470,306, filed on Jun. 1, 2023.

(51) Int. Cl. G06N 20/20

(52) U.S. Cl. CPC G06N 20/20

(57) ABSTRACT

An example method for method for predicting the fuel consumption of a powertrain is described herein. The method includes receiving vehicle data, the vehicle data including vehicle specification information and vehicle drive cycle information, inputting the data into a trained machine learning model; and predicting, using the trained machine learning model, a fuel consumption of a powertrain.

### CROSS-REFERENCE TO RELATED APPLICATIONS

This application claims the benefit of U.S. provisional patent application No. 63/470,306, filed on Jun. 1, 2023, and titled “MACHINE LEARNING-BASED METHODS AND SYSTEMS FOR PREDICTING VEHICLE PERFORMANCE,” the disclosure of which is expressly incorporated herein by reference in its entirety.

### STATEMENT REGARDING FEDERALLY FUNDED RESEARCH

This invention was made with government support under grant/contract number DE-EE0009207 awarded by the Department of Energy. The government has certain rights in the invention.

### BACKGROUND

The performance of road vehicles is important to understand and predict. For example, the performance of heavy trucks can be of interest to trucking companies, drivers, and government regulators. However, the performance of road vehicles can be difficult to predict because the performance of a given vehicle can depend on both the characteristics of the vehicle, as well as how it is driven. Improving the ability to predict the performance of different vehicles under different driving conditions is important for the design of vehicles and can help vehicle purchasers make better purchasing decisions.

### SUMMARY

Methods and systems for predicting, using machine learning models, vehicle performance based on vehicle data such as vehicle specifications and drive cycle information are described herein.

In some aspects, implementations of the present disclosure include a method for predicting a fuel consumption of a powertrain, the method including: receiving vehicle data, the vehicle data including vehicle specification information and vehicle drive cycle information; inputting the data into a trained machine learning model; and predicting, using the trained machine learning model, a fuel consumption of a powertrain.

In some aspects, implementations of the present disclosure include a method, wherein the trained machine learning model is a supervised machine learning model.

In some aspects, implementations of the present disclosure include a method, wherein the supervised machine learning model is a random forest classifier.

In some aspects, implementations of the present disclosure include a method, wherein the supervised machine learning model is an artificial neural network.

In some aspects, implementations of the present disclosure include a method, wherein the vehicle drive cycle information includes a vehicle speed profile, a road grade profile, weather data, and an acceleration profile.

In some aspects, implementations of the present disclosure include a method, wherein the vehicle specification information includes an engine profile, a transmission profile, a rear axle profile, and a body profile.

In some aspects, implementations of the present disclosure include a method for selecting an optimized powertrain, the method including: receiving vehicle data, the vehicle data including vehicle specification information and vehicle drive cycle information; inputting the vehicle data into a trained machine learning model; predicting, using the trained machine learning model, a fuel consumption of a powertrain; filtering the vehicle specification information and the vehicle drive cycle information to create a filtered data set; and performing a pareto optimization based on the filtered data set and the predicted fuel consumption of the powertrain to select a pareto optimal configuration.

In some aspects, implementations of the present disclosure include a method, wherein the trained machine learning model is a supervised machine learning model.

In some aspects, implementations of the present disclosure include a method, wherein the supervised machine learning model is a random forest classifier.

In some aspects, implementations of the present disclosure include a method, wherein the supervised machine learning model is an artificial neural network.

In some aspects, implementations of the present disclosure include a method, wherein the vehicle drive cycle information includes a vehicle speed profile, a road grade profile, weather data, and an acceleration profile.

In some aspects, implementations of the present disclosure include a method, wherein the vehicle specification information includes an engine profile, a transmission profile, a rear axle profile, and a body profile.

In some aspects, implementations of the present disclosure include a method, further including selecting a vehicle from a plurality of vehicles based on the pareto optimization.

In some aspects, implementations of the present disclosure include a method, wherein the drive cycle information includes route information corresponding to the route, and wherein the method further includes assigning a vehicle of a plurality of vehicles to travel along the based on the pareto optimization.

In some aspects, implementations of the present disclosure include a method of training a machine learning model to estimate fuel consumption, the method including: receiving training data; preprocessing the training data to obtain preprocessed training data; and training, based on the preprocessed training data, the machine learning model to predict fuel efficiency.

In some aspects, implementations of the present disclosure include a method, wherein the machine learning model includes a supervised machine learning model.

In some aspects, implementations of the present disclosure include a method, wherein the supervised machine learning model is a random forest classifier.

In some aspects, implementations of the present disclosure include a method, wherein the supervised machine learning model includes an artificial neural network.

In some aspects, implementations of the present disclosure include a method, wherein the training data includes drive cycle information and vehicle specification information.

In some aspects, implementations of the present disclosure include a method, wherein preprocessing the training data includes segmenting drive cycle information into a plurality of micro-trip cycles.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIGS. 1A-1C illustrate systems and methods for predicting the performance of a vehicle, according to implementations described herein. FIG. 1A illustrates a system diagram, including the inputs and outputs of the system. FIG. 1B illustrates a machine learning model for predicting fuel economy using an artificial neural network according to an implementation described herein. FIG. 1C illustrates a machine learning model for predicting fuel economy using a random forest model according to an implementation described herein.

FIG. 1D illustrates an example method of training a machine learning model to predict fuel efficiency, according to implementations of the present disclosure.

FIG. 2 is an example computing device.

FIG. 3 illustrates an example powertrain recommender system, according to implementations of the present disclosure.

FIG. 4A illustrates an example drive cycle, according to a study of an example implementation of the present disclosure.

FIG. 4B illustrates an example drive cycle where vehicle speed is a function of elevation, according to a study of an example implementation of the present disclosure.

FIG. 4C illustrates grade percentage as a function of time for the drive cycle of FIG. 4B.

FIG. 4D illustrates a drive cycle according to a study of an example implementation of the present disclosure.

FIG. 4E illustrates the drive cycle of FIG. 4D including micro-trip cycles with batch averages, according to a study of an example implementation of the present disclosure.

FIG. 5 illustrates example data processing steps that can be used in implementations of the present disclosure.

FIG. 6 illustrates an example block diagram of training a prediction model using a machine learning algorithm.

FIG. 7 illustrates example inputs that can be used to predict fuel consumption, according to implementations of the present disclosure.

FIG. 8 illustrates an example correlation analysis between full trip and micro trip drive cycles, according to a study of an implementation of the present disclosure.

FIG. 9A illustrates an example comparison of time distributions for full-trip and micro-trip data, according to a study of an implementation of the present disclosure.

FIG. 9B illustrates an example comparison of the distance distributions for full-trip and micro-trip data, according to a study of an implementation of the present disclosure.

FIG. 9C illustrates an example comparison of the average grade for the full-trip and micro-trip data, according to a study of an implementation of the present disclosure.

FIG. 9D illustrates an example comparison of the average speed for the example dataset, according to a study of an implementation of the present disclosure.

FIG. 10 illustrates an example of hyperparameter optimization for a random forest model, according to a study of an implementation of the present disclosure.

FIG. 11 illustrates an analysis for an example random forest model, according to a study of an implementation of the present disclosure.

FIG. 12 illustrates an example of training results for a neural network, according to a study of an implementation of the present disclosure.

FIG. 13A illustrates a plot of example predictions of fuel consumption using an example random forest model, according to a study of an implementation of the present disclosure.

FIG. 13B illustrates a plot of example predictions of fuel consumption using an example neural network, according to a study of an implementation of the present disclosure.

FIG. 14 illustrates an example system for selecting optimized vehicle power trains, according to implementations of the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for predicting vehicle performance of heavy-duty trucks, it will become evident to those skilled in the art that the implementations are not limited thereto, but are applicable for predicting vehicle performance of other vehicle types.

Described herein are machine learning-based systems and methods for predicting, using machine learning models, vehicle performance based on vehicle data such as vehicle specifications and drive cycle information. “Vehicle specification” as used herein, refers to the process of selecting a vehicles components and sizes (the vehicle's specifications).

Vehicle design involves complicated tradeoffs between different kinds, sizes, and combinations of components. The design of a vehicle affects the “vehicle data” which can include the vehicles specifications and drive cycle. For example, the powertrain of a vehicle can affect the weight and/or efficiency of a vehicle. Other vehicles specifications include the weight of the vehicle and/or its payload. As another example, the drive cycle of a vehicle can include the route that the vehicle takes, including numbers of starts and stops, speed profiles (time at different speeds, number/rate of accelerations and decelerations, etc), altitude changes, etc. The drive cycle of a vehicle can also include information about the vehicle's operations, for example whether a payload is transported one way on the route or both ways, and/or whether the mass of the payload changes during the route.

As an example situation, a designer or user of a vehicle may need to assess tradeoff between electric and gas/diesel powertrains for routes that include different speeds, altitudes, and payloads to select vehicles for each route that maximize efficiency, minimize cost, or any other optimization. Users of vehicles can include operators of fleets that include different types of vehicles, and benefit from tools that can select which vehicle in their fleet is optimized for a particular route, or which vehicle the user should acquire to be optimized for the route.

Implementations of the present disclosure include methods of generating recommendations of optimized vehicles based on vehicles specifications and drive cycles using machine learning. The implementations of the present disclosure described herein can use multiple vehicle specifications and drive cycle parameters, as well as user selections, to output recommended vehicles that are optimized for particular drive cycles and can therefore be beneficial for improving vehicle operations. Conventional optimization approaches are less effective when dealing with many different interrelated parameters, and therefore implementations of the present disclosure include improvements on conventional optimization approaches. Moreover, implementations of the present disclosure include improvements to machine learning systems and methods for modeling drive cycles and vehicle specifications for performing the optimizations and/or recommendations described herein.

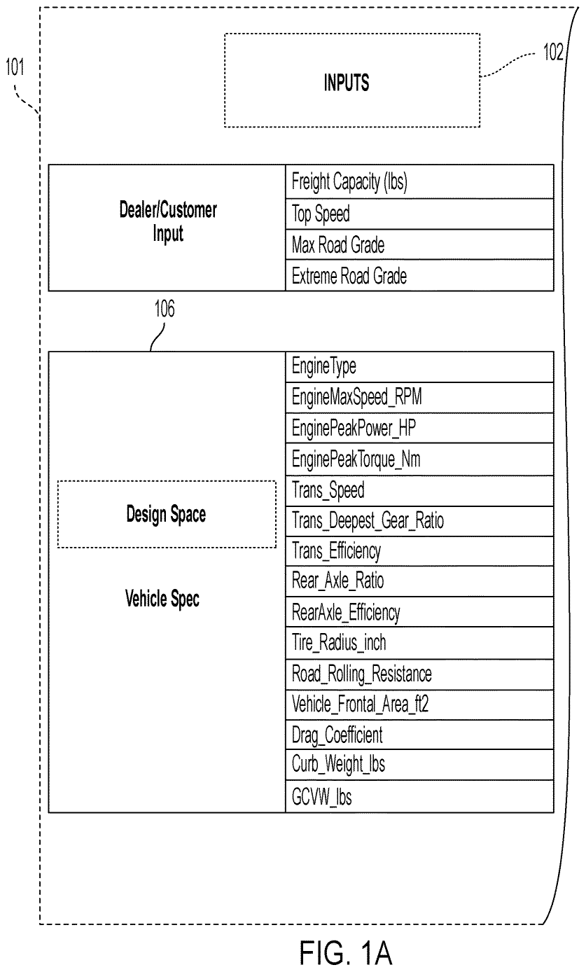

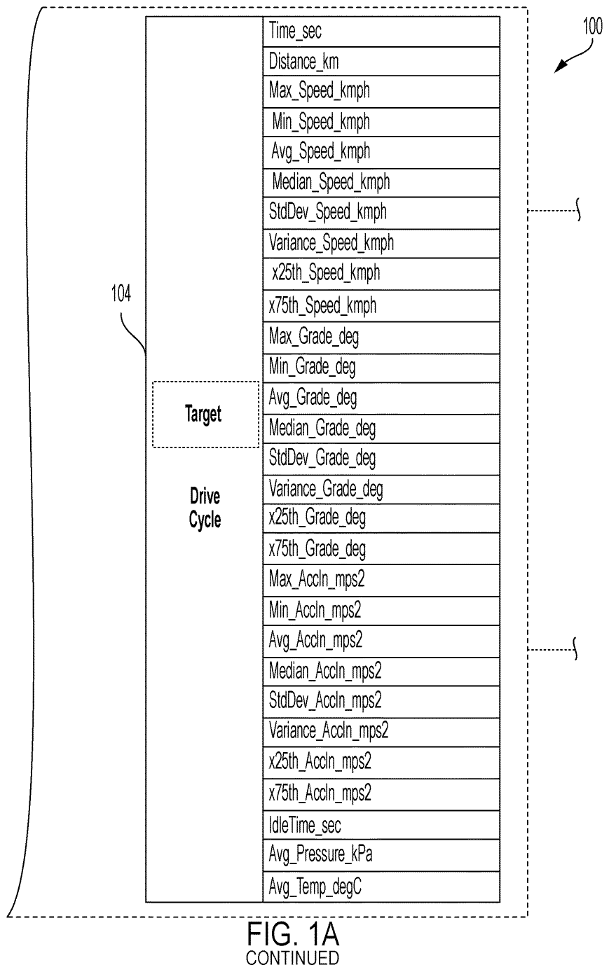

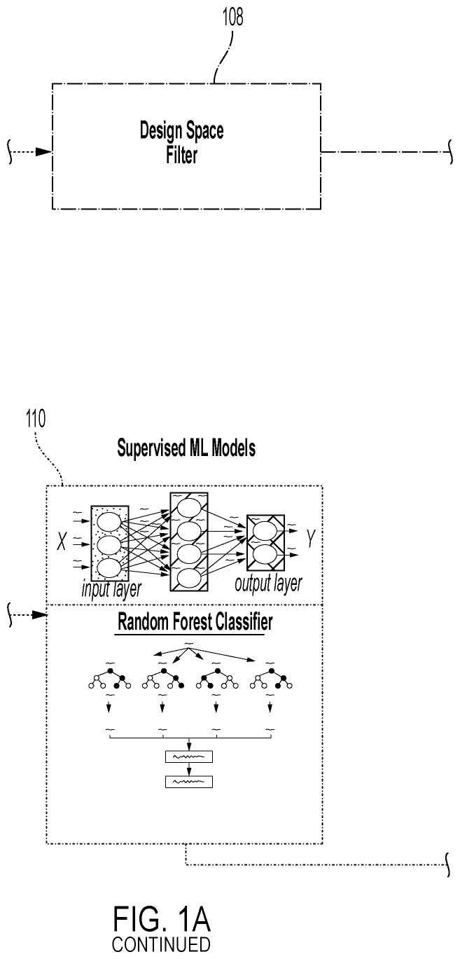

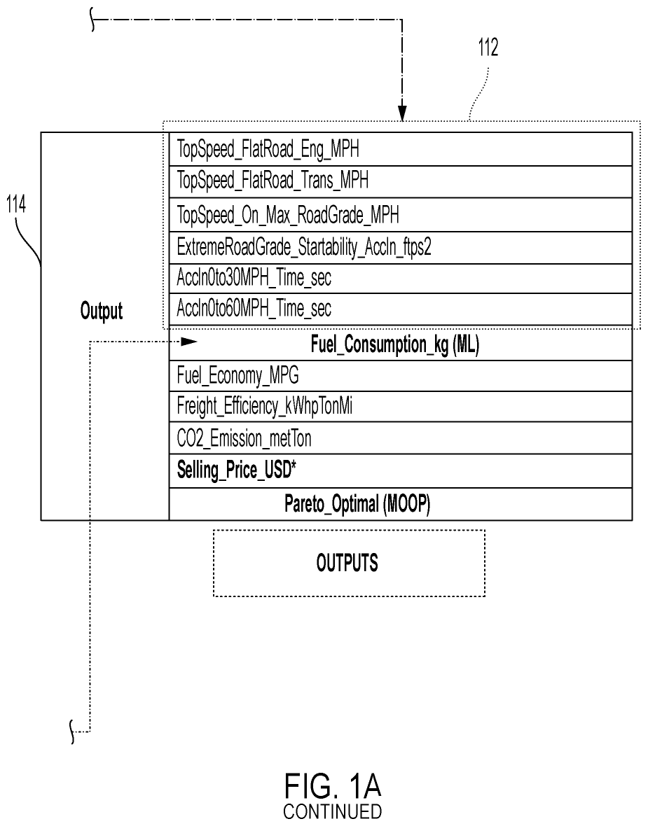

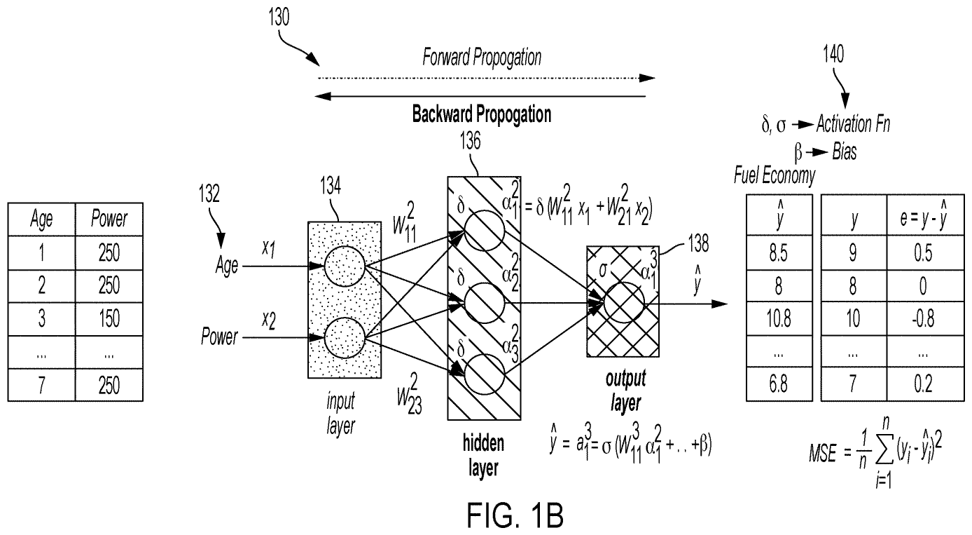

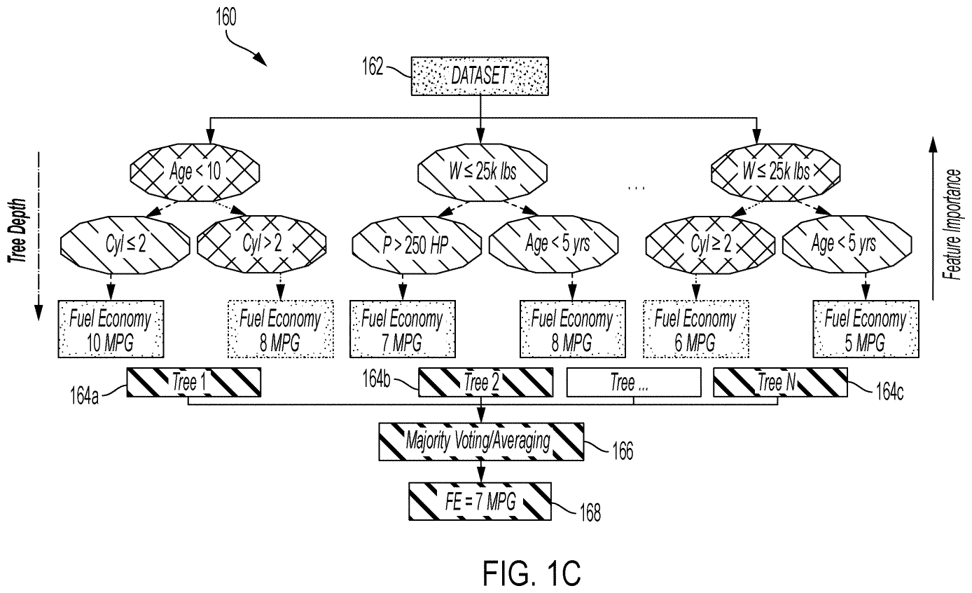

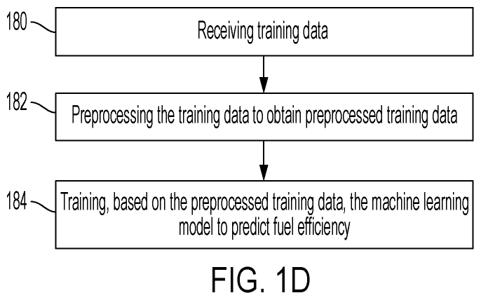

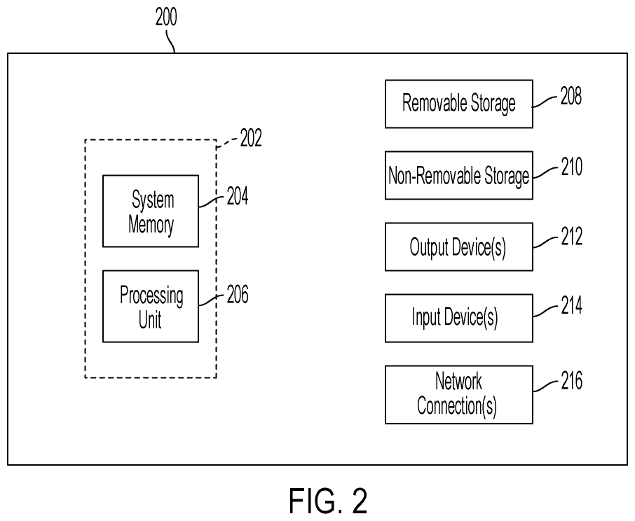

Referring now to FIG. 1A, a block diagram illustrating a system 100 for recommending a vehicle and/or vehicle powertrain based on predicted vehicle performance is shown. The system 100 can be configured to generate, using a machine learning model 110, outputs 112 based on a dataset 101. The machine learning model 110 can be implemented using one or more computing devices such as computing device 200 of FIG. 2. As described herein, the dataset 101 can include inputs 102 including a desired freight capacity, top speed, maximum road grade, and extreme road grade, as well as vehicle specification information and/or vehicle drive cycle information.

In some implementations, a machine learning model 110 is trained with the data set 101. Optionally, the machine learning model 110 is a supervised machine learning model. In a supervised learning model, the model learns a function that maps an input (also known as feature or features) to an output (also known as target or targets) during training with a labeled data set (or dataset). Supervised machine learning models include, but are not limited to, random forest classifier and artificial neural networks. This disclosure contemplates that the machine learning model 110 can be other types of models including, but not limited to, a logistic regression model, a logistic classifier model, or a support vector machine. As described herein, a supervised learning model is trained with the data set to minimize the cost function. Cost functions include, but are not limited to, errors such as L1 loss or L2 loss. During training, the supervised learning model's node weights and/or bias are tuned to minimize the cost function. This disclosure contemplates that any algorithm that finds the minimum of the cost function can be used for training the supervised learning model. At the conclusion of training, the trained machine learning model 110 is configured to predict the fuel consumption or fuel efficiency (i.e., the performance) of a vehicle or powertrain. In other words, the trained machine learning model 110 is capable of operating in inference mode such that a target (or targets) (e.g., output 114 shown in FIG. 1A) can be predicted based on one or more of the inputs (e.g., one or more of the inputs 102 shown in FIG. 1A). Throughout the present disclosure, the terms “fuel consumption” and “fuel efficiency” are used interchangeably to refer to estimates of how much fuel a vehicle will consume under certain conditions.

The dataset 101 can include drive cycle information 104. Drive cycle information can include, but is not limited to, information about the distance traveled by the vehicle, the speed of the vehicle, road grade profile, acceleration profile of the vehicle, idle time of the vehicle, and weather information (e.g., pressure and/or temperature). The speed of the vehicle can be represented by a profile including information about the speed of the vehicle over time. The information about the speed of the vehicle over time can be statistically analyzed to obtain different statistical measures. Non-limiting examples of statistics that can be obtained from the speed profile include the maximum speed, minimum speed medium speed, average speed standard deviation of speed, variance of the speeds, and the 25^{th} and 75^{th} percentile speeds.

Similarly, road grade profile can contain information about the grade (i.e. slope) of the road during the drive cycle. The road grade profile can be statistically analyzed to generate a maximum grade minimum grade, average grade, median grade, standard deviation of the grades, variance of the grades, standard deviation of the grades, as well as the 25^{th} and 75^{th} percentile grades.

The acceleration of the vehicle can also be represented by an acceleration profile including the acceleration of the vehicle over time. The acceleration profile can be analyzed to again obtain the maximum, minimum, median, average, acceleration, as well as the standard deviation, variance, and 25^{th} and 75^{th} percentile acceleration. Non-limiting examples of weather inputs include the average pressure and temperature.

The dataset 101 can include information about the vehicle specification information 106. Vehicle specification information 106 can include, but is not limited to, information about the engine, the transmission, the rear axle, the tires, and the body of the vehicle. Non limiting examples of information about the engine include the type of engine, the maximum speed in RPM, the peak power of the engine (e.g., horsepower), and the peak torque of the engine. Non-limiting examples information about the transmission include the transmission speed, information about the gear ratios, and information about the efficiency of the transmission. Non-limiting examples of information about the rear axle include the rear axle ratio and rear axle efficiency. Similarly, information about the tires can include the radius of the tires and the road rolling resistance of the tires. Information about the body can include information about the vehicle frontal area, drag coefficient, curb weight, and GCVW (gross combined vehicle weight rating). It should be understood that the vehicle specification information can be in any units.

FIG. 1A also shows a machine learning model 110. The machine learning model 110 is trained to map an input (e.g., one or more inputs in the dataset 101) to the output 114. In the examples described herein, the input is the dataset 101, and the output 114 is a predicted fuel consumption or fuel economy. The dataset 101 includes one or more “features” that are input into the machine learning model 110, which predicts the fuel economy for the vehicle or powertrain. The fuel consumption is therefore the “target” of the machine learning model 110.

The inputs to the machine learning model 110 can be filtered. Example filtering operations can include rejecting data from the dataset 101, e.g., rejecting data representing very short trips, or data that is incomplete. Additional non-limiting examples of filtering operations that can be performed include removing duplicate data and smoothing noise in the data.

The machine learning model 110 can be a supervised machine learning model that is configured (e.g., trained) to predict the fuel economy of a vehicle based on some or all of the features contained in the dataset 101. Non-limiting examples of machine learning models that can be used include random forest models and neural networks.

As shown in FIG. 1A, a design space filter 108 can be applied to the dataset 101. The data filtered by the design space filter 108 can be used with the output 114 of the machine learning model 110 to perform an optimization. As a non-limiting example, a pareto optimization can be performed on the outputs 112 and/or output 114 of the machine learning model 110 to generate recommendations based on the dataset 101. Non-limiting examples of recommendations include a recommended vehicle, or a recommended powertrain of a vehicle.

Optionally, the machine learning model 110 in FIG. 1A is an artificial neural network. As shown in FIG. 1B, a neural network 130 (also referred to herein as an “NN” “ANN” or “Artificial neural network”) is shown that can be used as the machine learning model 110 of FIG. 1A. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can optionally be arranged in a plurality of layers such as input layer 134, output layer 138, and one or more hidden layers 136. Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer 134 receive data (sometimes referred to as “features” or input 132) from outside of the ANN, nodes in the hidden layer(s) 136 modify the data between the input 132 and output layers 138, and nodes in the output layer provide the results (sometimes referred to as “target” or output 140). Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a data set to minimize the cost function, which is a measure of the ANN's performance (e.g., error such as L1 or L2 loss). The training algorithm tunes the node weights and/or bias to minimize the cost function. This disclosure contemplates that any algorithm that finds the minimum of the cost function can be used for training the ANN. Training algorithms for ANNs include, but are not limited to, backpropagation and forward propagation. It should be understood that an artificial neural network 130 is provided only as an example machine learning model.

In FIG. 1B, the neural network 130 is operating in inference mode. The neural network 130 has therefore been trained with a data set (or “dataset”). The neural network 130 in FIG. 1B is a supervised learning model. Supervised learning models are known in the art. A supervised learning model “learns” a function that maps an input 132 (also known as feature or features) to an output 140 (also known as target or targets) during training with a labeled data set. The neural network illustrated in FIG. 1B maps inputs 132 to an output 140, e.g., predicted fuel economy.

FIG. 1C illustrates a random forest model 160 that can be used as the machine learning model 110 shown in FIG. 1A. The dataset 162 is input into one or more decision trees 164a 164b 164c that make up the random forest model 160. The outputs of the decision trees 164a 164b 164c are combined 166. Non-limiting examples of methods of combining the outputs of decision trees 164a 164b 164c include majority voting and averaging. The result of the majority voting or averaging is the model prediction 168, which in this case is a predicted fuel efficiency of 7 miles per gallon. It should be understood that any number of trees can be used, and that the three trees 164a 164b 164c shown in FIG. 1C are intended only as a non-limiting example.

FIG. 1D illustrates an example method of training a machine learning model to estimate fuel consumption according to implementations of the present disclosure.

At step 180, the method includes receiving training data. The training data can include any or all of the dataset 101 shown in FIG. 1A. For example, the training data can be vehicle specification information 106 and/or drive cycle information 104 described with reference to FIG. 1A.

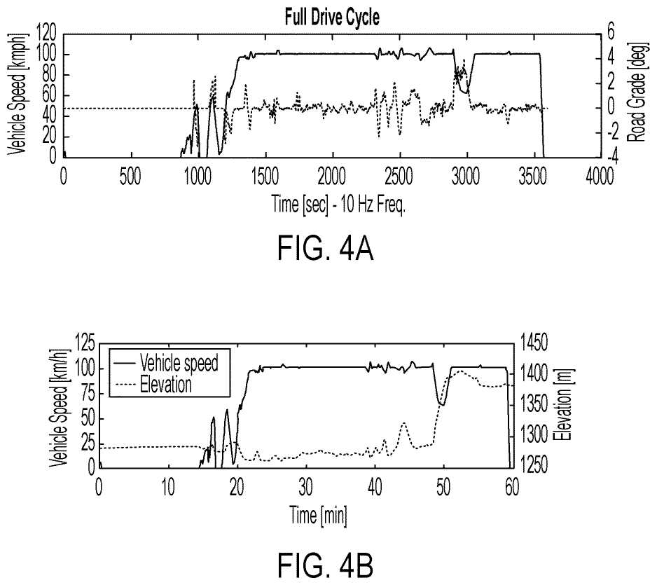

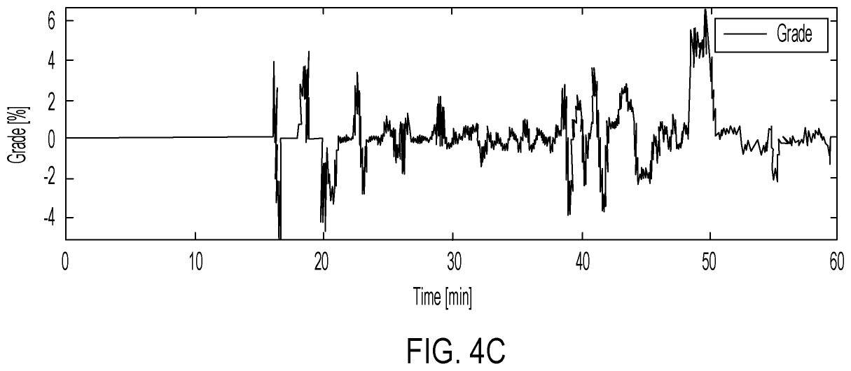

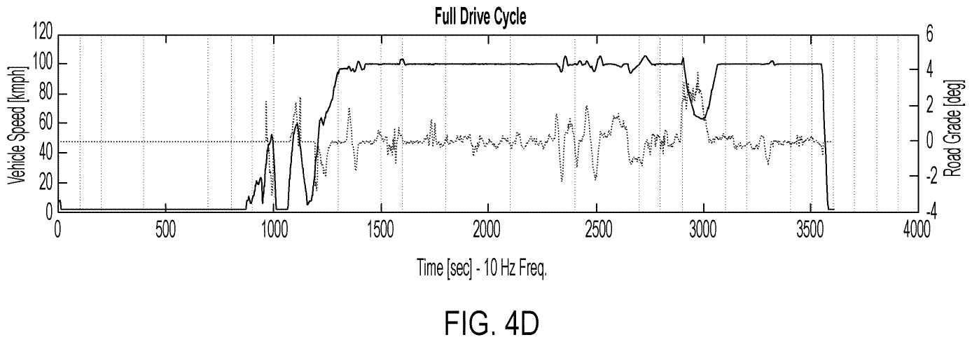

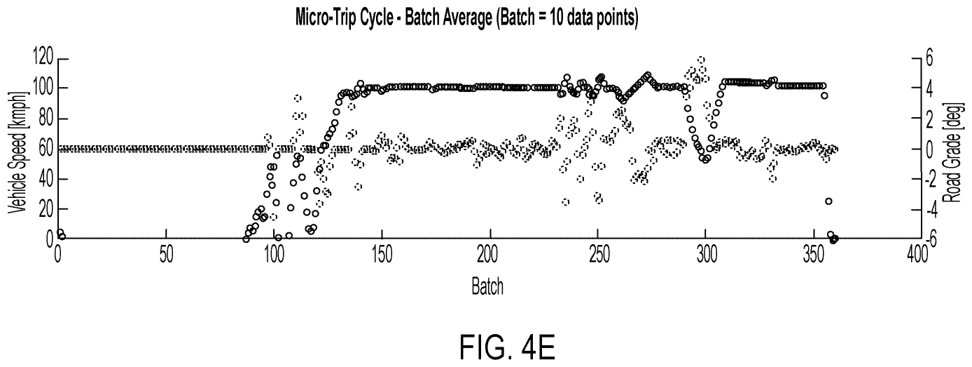

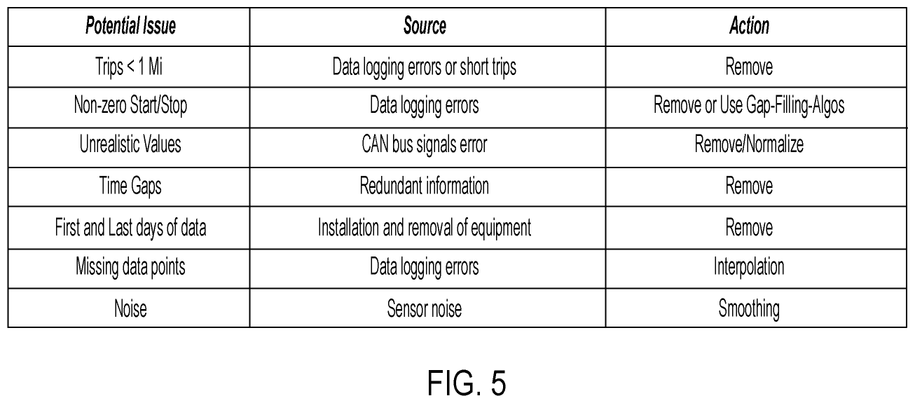

At step 182, the method can include preprocessing the training data to obtain preprocessed training data. Pre-processing training data can include batching the drive-cycle information into micro-trip cycles (e.g., as described with reference to FIG. 4E and the Example) and/or removing errors, normalizing data, interpolating, smoothing, and gap filling, as described with reference to FIG. 5. Batching the information into smaller drive cycles (e.g., 10 data points each) can be used to improve machine learning training for the training data described herein (e.g., drive cycle information) because the drive cycle information can include large numbers of values over a long period of time. Batching the training data can reduce the number of separate total data points by grouping them into batches, making machine learning training more efficient, for example by reducing the memory required for training a machine learning model with a large amount of training data (e.g., many drive cycles). Additionally, batching can reduce the effect of outlier values (e.g., noise).

It should be understood that different numbers of data points can be batched in different implementations of the present disclosure.

At step 184, the method can include training, based on the preprocessed training data, the machine learning model to predict fuel efficiency. The machine learning model trained at step 184 can be any of the machine learning models described herein, including, for example, a supervised machine learning model (e.g., random forest classifier) or neural network.

It should be appreciated that the logical operations described herein with respect to the various figures may be implemented (1) as a sequence of computer implemented acts or program modules (i.e., software) running on a computing device (e.g., the computing device described in FIG. 2), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 2, an example computing device 200 upon which the methods described herein may be implemented is illustrated. It should be understood that the example computing device 200 is only one example of a suitable computing environment upon which the methods described herein may be implemented. Optionally, the computing device 200 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 200 typically includes at least one processing unit 206 and system memory 204. Depending on the exact configuration and type of computing device, system memory 204 may be volatile (such as random access memory (RAM)), non-volatile (such as read-only memory (ROM), flash memory, etc.), or some combination of the two. This most basic configuration is illustrated in FIG. 2 by dashed line 202. The processing unit 206 may be a standard programmable processor that performs arithmetic and logic operations necessary for operation of the computing device 200. The computing device 200 may also include a bus or other communication mechanism for communicating information among various components of the computing device 200.

Computing device 200 may have additional features/functionality. For example, computing device 200 may include additional storage such as removable storage 208 and non-removable storage 210 including, but not limited to, magnetic or optical disks or tapes. Computing device 200 may also contain network connection(s) 216 that allow the device to communicate with other devices. Computing device 200 may also have input device(s) 214 such as a keyboard, mouse, touch screen, etc. Output device(s) 212 such as a display, speakers, printer, etc. may also be included. The additional devices may be connected to the bus in order to facilitate communication of data among the components of the computing device 200. All these devices are well known in the art and need not be discussed at length here.

The processing unit 206 may be configured to execute program code encoded in tangible, computer-readable media. Tangible, computer-readable media refers to any media that is capable of providing data that causes the computing device 200 (i.e., a machine) to operate in a particular fashion. Various computer-readable media may be utilized to provide instructions to the processing unit 206 for execution. Example tangible, computer-readable media may include, but is not limited to, volatile media, non-volatile media, removable media and non-removable media implemented in any method or technology for storage of information such as computer readable instructions, data structures, program modules or other data. System memory 204, removable storage 208, and non-removable storage 210 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 206 may execute program code stored in the system memory 204. For example, the bus may carry data to the system memory 204, from which the processing unit 206 receives and executes instructions. The data received by the system memory 204 may optionally be stored on the removable storage 208 or the non-removable storage 210 before or after execution by the processing unit 206.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

An example implementation of the present disclosure was designed and tested in a study of an example implementation of the present disclosure configured to recommend vehicle specifications (e.g., truck powertrains) to a user (e.g., vehicle operator acquiring a vehicle for an operation). As a non-limiting example, the example implementation was configured to recommend powertrains for trucks to the user.

For example, a fleet owner who purchases heavy-duty trucks can select trucks for type of routes. Different powertrains can be selected for different vehicles, so optimization of the vehicle specs and the powertrain for specific operation and/or route is possible. The study further included implementations directed to fleet operations management and vehicle routing. For example, telematics data (e.g., GPS and/or any other sensor data that tracks a vehicle's position, orientation, velocity, acceleration, etc.) can be used to select/manage the assignment of vehicles to routes, or alternatively/additionally to identify optimal routes for vehicles.

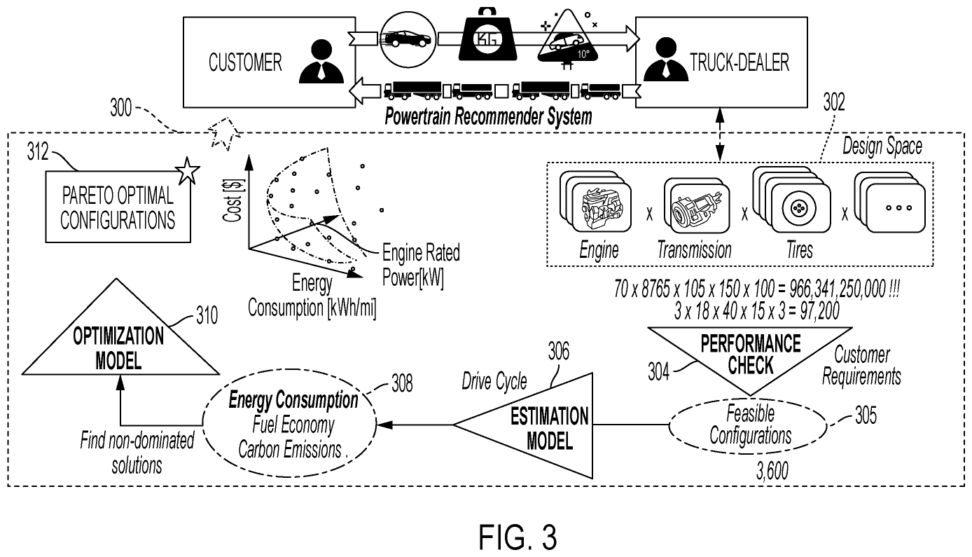

With reference to FIG. 3, an example implementation of the present disclosure is illustrated. The example implementation includes a powertrain recommender system 300. The powertrain recommender system 300 can be configured to evaluate performance of one or more vehicles, estimate energy consumption of one or more vehicles, and/or find pareto optimal configurations of vehicles specifications (e.g., cost, engine rated power, and/or energy consumption).

As shown in FIG. 3, the example system can include a design space 302. The design space 302 can include the combinations of vehicle components that are available. As shown in FIGS. 3, example vehicle components can include engines, transmissions, tires, etc. Additional non-limiting examples of vehicle specification information that can be included in the design space 302 include engine, transmission, rear axel, vehicle chassis/body, aerodynamics, and/or mass.

A performance check 304 can be applied to determine which combinations of vehicle components satisfy requirements. The requirements can optionally be requirements input by a user, or requirements selected based on a fleet management system or other automated system that determines the requirements required for a vehicle operation and/or route. The performance check 304 can be used to filter the design space to a smaller number of potential configurations.

Feasible configurations 305 can be identified by performance check 304. The feasible configurations can be input to an estimation model 306 that can optionally include a drive cycle. The estimation model 306 can output an energy consumption estimate 308. Optionally the energy consumption estimate 308 can include fuel economy and/or carbon emissions. Non-dominated solutions (e.g., solutions that cannot be improved in one way without decreasing their performance in another way) can be identified from the energy consumption estimate 308 and input into an optimization model 310. The optimization model can be configured to output pareto optimal configurations 312. Optionally, the pareto optimal configuration 312 can be based on an estimate of energy consumption as a function of drive cycle and vehicle specification.

FIG. 4A illustrates an example drive cycle that can be used in the estimation model 306. Additional non-limiting examples of drive cycle information that can be used include vehicle speed profile, road grade profile, distance, time, weather (e.g., temperature and/or pressure), and fuel flow rate.

FIG. 4B-4C illustrates another example drive cycle. FIG. 4B illustrates vehicle speed as a function of elevation and FIG. 4C illustrates an example of grade % as a function of time for the drive cycle of FIG. 4B.

FIG. 4D illustrates yet another example drive cycle, according to implementations of the present disclosure. Optionally, the drive cycle shown in FIG. 4D can be represented as a micro-trip cycle with batch averages, as shown in FIG. 4E.

Optionally, implementations of the present disclosure can include data processing steps. Non-limiting data processing steps that can be used for example types of issues are illustrated in FIG. 5. As shown in FIG. 5, data resulting from logging errors, signal errors, redundant information, etc. can be removed, smoothed, normalized, gap filled and/or interpolated, for example. It should be understood that the types of issues, sources, and actions shown in FIG. 5 are intended only as non-limiting examples.

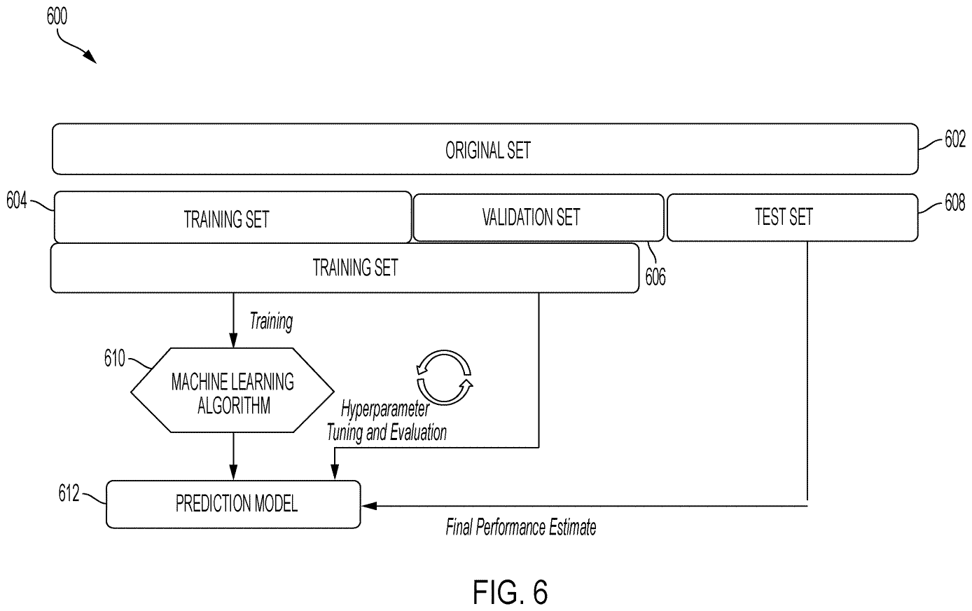

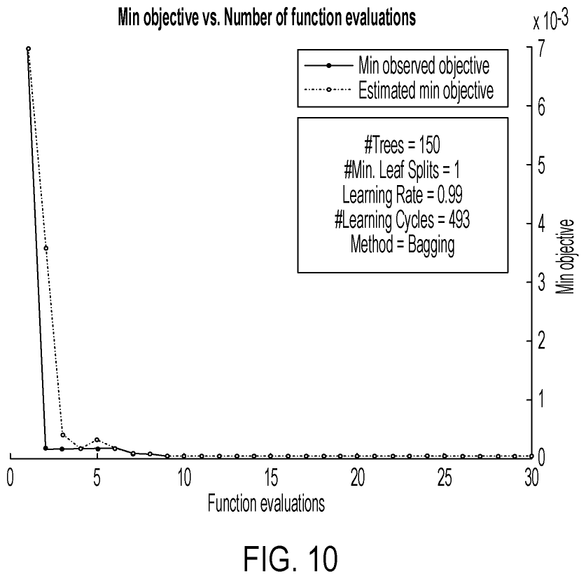

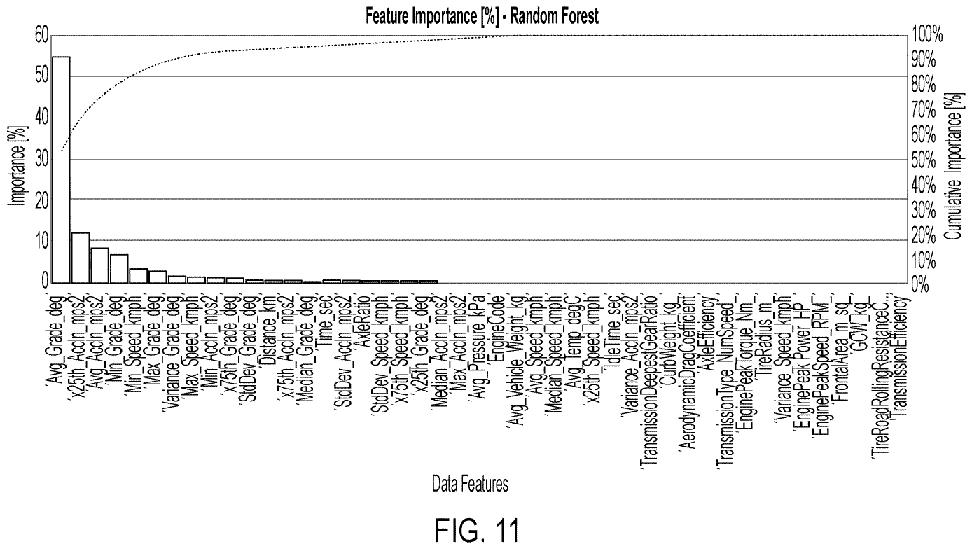

FIG. 6 illustrates an example block diagram 600 showing training of a prediction model 612 using a machine learning algorithm 610. An original dataset 602 including drive cycle information and/or vehicle specifications can be subdivided into a training set 604, validation set 606, test set 608. In some implementations, the machine learning algorithm 610 can be a random forest model as described herein with reference to FIG. 1C, for example. An example of hyperparameter optimization for a random forest model is illustrated in FIG. 10. Example hyperparameters include tree depth, learning rate, minimum leaf size, number of learning cycles, minimum number of splits, and training method (e.g., bagging vs boosting). The study further included an analysis of feature importance for an example random forest model, as shown in FIG. 11.

The random forest model can be configured for the prediction models described herein (e.g., prediction model 612). The random forest model can be configured to use less data, use both linear and non-linear relationships, provide good accuracy, use less (or no) validation data, and implicitly perform feature selection, any or all of which can be improvements over alternative machine learning models.

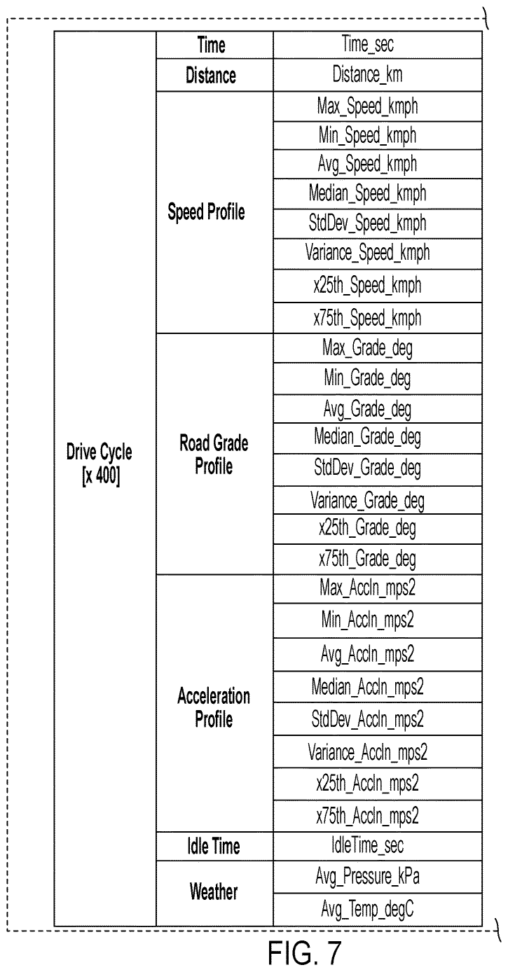

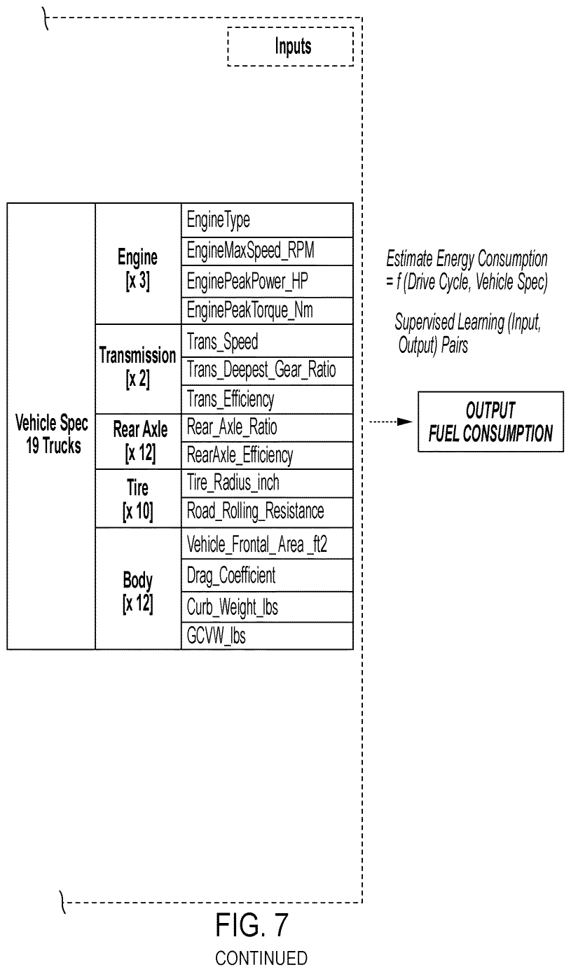

FIG. 7 illustrates additional non-limiting examples of drive cycle and vehicle specification inputs that can be used as training data in implementations of the present disclosure (e.g., the original dataset 602 and/or training set 604 of FIG. 6).

Additional examples of training data used in the study of the example implementation are described herein with reference to FIG. 1A.

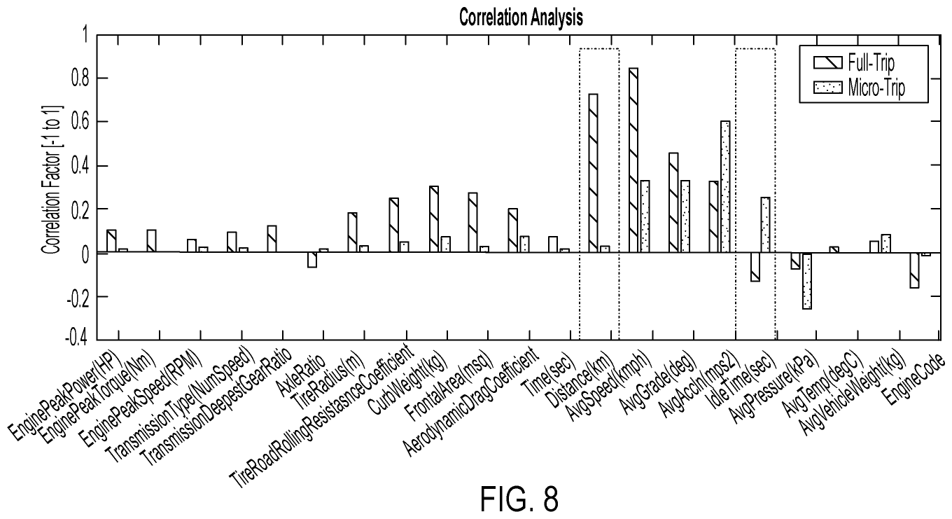

The study included an analysis of correlation between full-trip and micro-trip data. FIG. 8 illustrates an example correlation between full-trip and micro-trip data with respect to fuel consumption, for an example dataset including 19 trucks and 400 drive cycles.

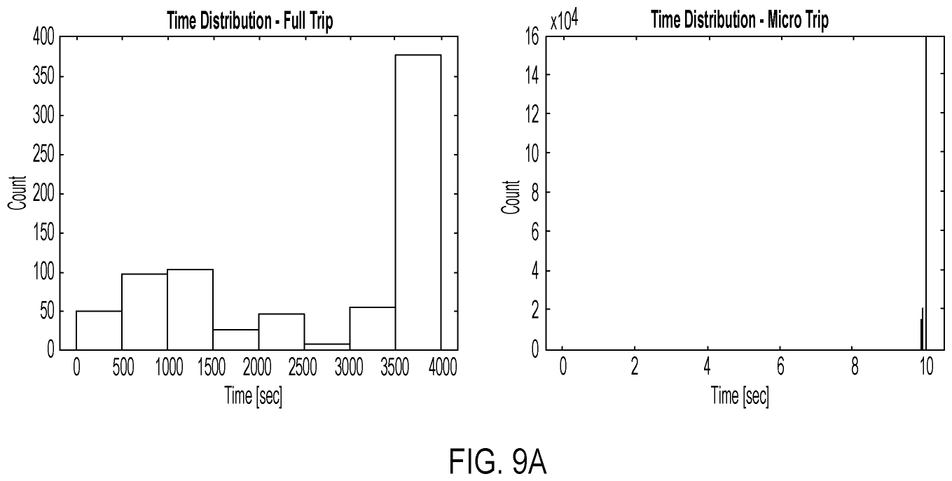

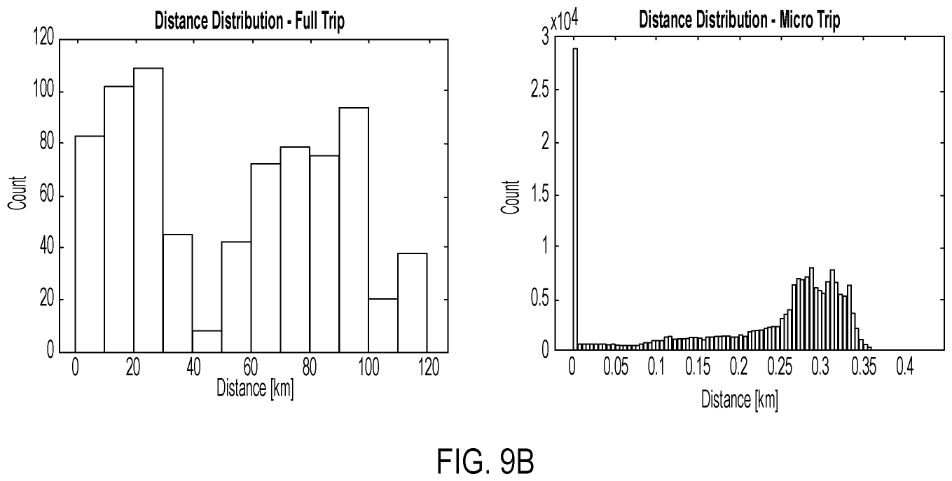

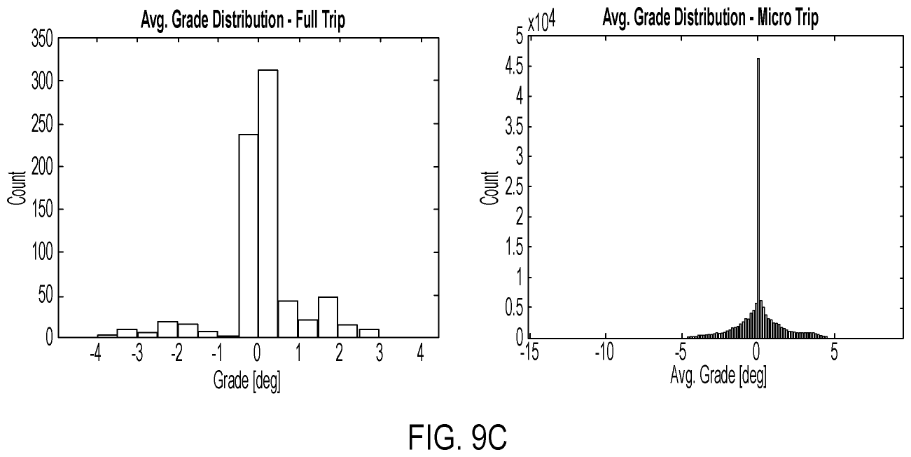

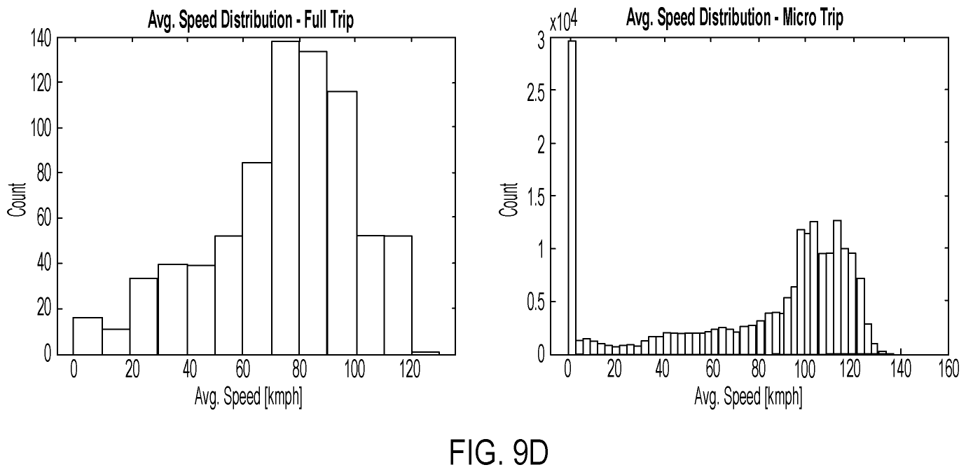

The study further included analyses of the distributions of: time, distance, average grade, and average speed, for the example dataset. FIG. 9A illustrates an example comparison of the time distributions for full-trip and micro-trip data. FIG. 9B illustrates an example comparison of the distance distributions for full-trip and micro-trip data. FIG. 9C illustrates an example comparison of the average grade for the full-trip and micro-trip data. FIG. 9D illustrates an example comparison of the average speed for the example dataset.

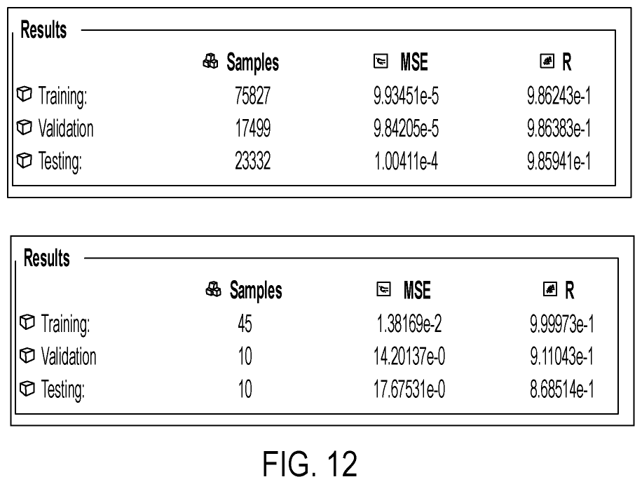

The study further included an analysis of training a neural network. A description of a neural network used in the study is described with reference to FIG. 1B herein. Example hyperparameters used in the study include learning rate, number of hidden layers, number of neurons in hidden layers, activation functions, optimizer, batch sizes, and epochs. FIG. 12 illustrates example of training results for a neural network according to an implementation of the present disclosure.

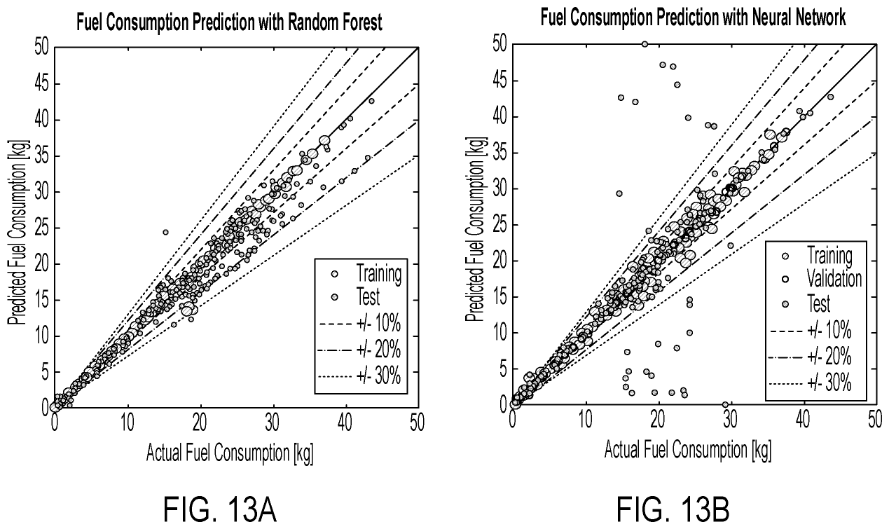

FIGS. 13A and 13B illustrate a comparison of an example random forest model and example neural network. FIG. 13A illustrates a plot based on 400 drive cycles and 19 trucks, including training and test data, where the predictions were performed using a random forest model. FIG. 13B illustrates a plot based on 400 drive cycles and 19 trucks, where the predictions were performed with a neural network.

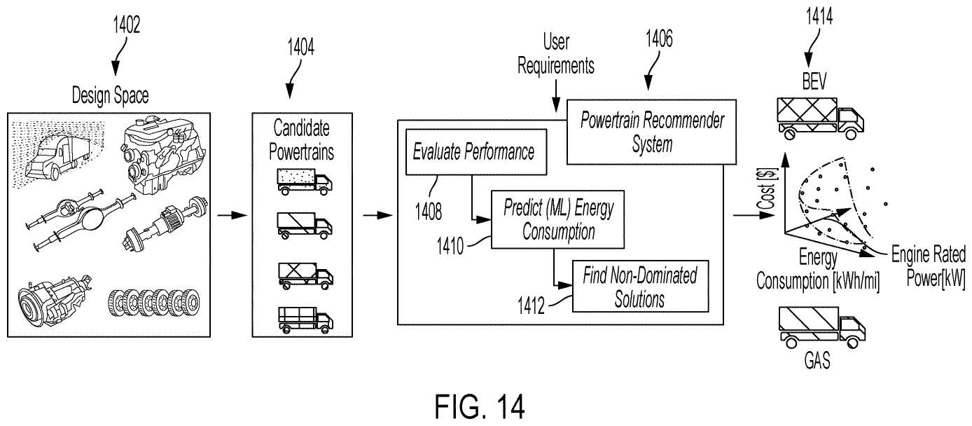

FIG. 14 illustrates an example system block diagram according to implementations of the present disclosure. The example system block diagram includes design space 1402, which can be used to generate a set of candidate powertrains 1404. The candidate powertrains can be input into a powertrain recommender system 1406.

The powertrain recommender system 1406 can include performance evaluation 1408 of the candidate powertrains 1404 to identify a subset of the candidate powertrains that meet user requirements (e.g., powertrains that are suitable for a route and/or operation), performing a prediction of energy consumption 1410, optionally using machine learning, and identifying non-dominated solutions 1412. Results 1414 output by the example shown in FIG. 14 can include optimizations between various vehicle specifications including cost, power, and energy consumption, which can optionally include a pareto optimization.

The subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for predicting a fuel consumption of a powertrain, the method comprising:
receiving vehicle data, the vehicle data comprising vehicle specification information and vehicle drive cycle information;
inputting the data into a trained machine learning model; and
predicting, using the trained machine learning model, a fuel consumption of a powertrain.

2. The method of claim 1, wherein the trained machine learning model is a supervised machine learning model.

3. The method of claim 2, wherein the supervised machine learning model is a random forest classifier.

4. The method of claim 2, wherein the supervised machine learning model is an artificial neural network.

5. The method of claim 1, wherein the vehicle drive cycle information comprises a vehicle speed profile, a road grade profile, weather data, and an acceleration profile.

6. The method of claim 1, wherein the vehicle specification information comprises an engine profile, a transmission profile, a rear axle profile, and a body profile.

7. A method for selecting an optimized powertrain, the method comprising:
receiving vehicle data, the vehicle data comprising vehicle specification information and vehicle drive cycle information;
inputting the vehicle data into a trained machine learning model;
predicting, using the trained machine learning model, a fuel consumption of a powertrain;
filtering the vehicle specification information and the vehicle drive cycle information to create a filtered data set; and
performing a pareto optimization based on the filtered data set and the predicted fuel consumption of the powertrain to select a pareto optimal configuration.

8. The method of claim 7, wherein the trained machine learning model is a supervised machine learning model.

9. The method of claim 8, wherein the supervised machine learning model is a random forest classifier.

10. The method of claim 8, wherein the supervised machine learning model is an artificial neural network.

11. The method of claim 7, wherein the vehicle drive cycle information comprises a vehicle speed profile, a road grade profile, weather data, and an acceleration profile.

12. The method of claim 7, wherein the vehicle specification information comprises an engine profile, a transmission profile, a rear axle profile, and a body profile.

13. The method of claim 7, further comprising selecting a vehicle from a plurality of vehicles based on the pareto optimization.

14. The method of claim 7, wherein the drive cycle information comprises route information corresponding to the route, and wherein the method further comprises assigning a vehicle of a plurality of vehicles to travel along the based on the pareto optimization.

15. A method of training a machine learning model to estimate fuel consumption, the method comprising:
receiving training data;
preprocessing the training data to obtain preprocessed training data; and
training, based on the preprocessed training data, the machine learning model to predict fuel efficiency.

16. The method of claim 15, wherein the machine learning model comprises a supervised machine learning model.

17. The method of claim 16, wherein the supervised machine learning model is a random forest classifier.

18. The method of claim 16, wherein the supervised machine learning model comprises an artificial neural network.

19. The method of claim 15, wherein the training data comprises drive cycle information and vehicle specification information.

20. The method of claim 19, wherein preprocessing the training data comprises segmenting drive cycle information into a plurality of micro-trip cycles.
